(19) United States
(12) Patent Application Publication
(10) Pub. No.: US 2013/0045110 A1
(43) Pub. Date: Feb. 21, 2013

(54) LIFTING DEVICE FOR A ROTOR OF A WIND TURBINE

(71) Applicant: Juergen Wagner, Berlin (DE)

(72) Inventor: Juergen Wagner, Berlin (DE)

(73) Assignee: SUZLON ENGERGY GMBH, Rostock (DE)

(21) Appl. No.: 13/394,376

(22) PCT Filed: Sep. 6, 2010
(86) PCT No.: PCT/EP2010/063030

§ 371 Date: Apr. 16, 2012

(30) Foreign Application Priority Data
Sep. 7, 2009 (DE) 102009040235.7

(51) Int. Cl. F03D 11/04

(52) U.S. Cl. 416/244 R

(57) ABSTRACT

The invention relates to a lifting device for a rotor of a wind turbine, consisting of a turbine hub and rotor blades fixed thereon, having the following components: at least one receiving device which can be fixed to a blade root region of the rotor; guiding means which can be attached to the receiving device and which has at least one carrier element for receiving and fixing cable carriers, wherein the carrier element is connected to the guiding means in a movement-flexible manner such that the rotor is aligned properly for assembly before being assembled on a rotor shaft of the wind turbine. The aim of the invention is to provide a lifting device for rotors which is easy to assemble and disassemble and which enables the rotor to automatically align into a correspondingly optimal bearing position for assembling onto the turbine hub when undesired torque acts on said rotor.

### TECHNICAL FIELDS

The present invention relates to a lifting device for a rotor of a wind turbine. Such a rotor consists substantially of a turbine hub and rotor blades fixed thereon. The lifting device here has at least one receiving device which can be fixed to a blade root region of the rotor.

### PRIOR ART

Such a lifting device is known from the prior art. In general, wind turbines and their components have extreme dimensions that make it become necessary from economic aspects to assemble the individual components only at the installation sites. The installation of a rotor of a wind turbine to a flange on the rotor shaft in the turbine casing is here usually accomplished with a crane. This crane is equipped with pulleys which can lift the rotor to the appropriate height. In the simplest case, the pulleys have loops, which are placed around a rotor blade region to hold the rotor before lifting. However, problems often occur in this type of pulleys, which make a lifting of the rotor and a assembling onto the turbine housing evidently more difficult, particularly for larger wind turbine facilities. On the one hand, the loops of the pulleys that are placed around the rotor blade region can favor the appearance of friction and adhesion forces. This is particularly disadvantageous, since through this adhesion and friction forces the center of gravity of the crane suspension is abruptly shifted in such a way that a torque is generated, which causes the rotor to make an abrupt movement. Thereby, it makes the exact orientation of the rotor much more difficult. In order to prevent this, numbers of cranes are required during the assembly of the rotor. Furthermore, the loops could damage the rotor blades.

Another possibility of lifting the rotor with the pulleys is to provide the rotor with a corresponding holding device, on which a pulley or a hook of a pulley can be fixed. Although the disadvantages of the appearing frictional forces can be thereby prevented, a need results from this solution to equip the rotor with a holding device, the holding device is preferably directly fixed on the support body of the hub. Also, it is neither technically easy to implement, nor economically very advisable, particularly for rotors of already installed facilities, to retrofit such a holding device.

### SUMMARY OF THE INVENTION

It is an object of the invention to improve a lifting device for a rotor of a wind turbine, which among other things, avoids the disadvantages of the prior art. In particular, a fully and holistically improved lifting device should be specified, wherein the assembly and disassembly of the lifting device on the rotor can be carried out quickly and easily, particularly without making any changes to the existing design of a rotor. In addition, through the solution to the lifting device according to present invention, the stability of the rotor during the lifting process and the assembly onto the turbine housing should be increased so that a fast and reliable alignment of the rotor is possible.

This object is solved by the features of claim 1 in a manner that the receiving device is firmly but detachably connectable to the blade root region, guiding means and at least one carrier element for receiving and fastening cable carriers are arranged on the receiving device. Here, the carrier element is connected to the guiding means in a movement-flexible manner. This movement flexibility of the carrier element, which is preferably formed as displacing ability, enables for the first time that the rotor can be compatibly for assembly aligned with respect to a flange of a rotor shaft of the wind turbine before being assembled. This means, on the carrier elements, the entire rotor is movable suspended on a crane by means of the guiding means, wherein the movability allows that the rotor can hang on the crane in various positions. This is necessary since the rotor is substantially horizontally supported on the floor before the assembling. During the assembling onto the rotor flange of the rotor shaft of the wind turbine, the rotor must on the one hand be lifted to the height of the nacelle and on the other hand be rotated from the horizontal position to a substantially vertical position. The displacing ability of the suspension or the carrier elements enabling the rotation requires an especially simple, smooth and damage-free assembling.

In a first embodiment of the invention, it is provided that the receiving device of the lifting device is composed of at least two half-shells. This brings the advantage that the lifting device can be relatively easily mounted on the rotor blade region of an already installed facility or a facility to be installed and can be disassembly again. The lifting device is also applicable to different types of facilities. On the rotor itself, no constructive interventions are needed to provide the necessary hold and the strength of the lifting device. The integrating of the half-shells can be achieved, e.g. via a clip-like connection which is implemented via plug-in and/or screw sets. All kinds of form-fit and/or force-fit connections that hold the half-shells together would also be conceivable.

In a further embodiment, it is provided that the guiding means of the lifting device possesses a guiding plane with a sliding carriage mounted thereon, wherein the sliding carriage is limitedly movable in at least one degree of freedom along the guiding plane. The guiding plane can here be constructed as a rail-like running track, which is mounted on a half shell. In this way it is ensured that the rotor can bring itself during the lifting process automatically into an optimal initial position for the installation onto the turbine housing and is oriented accordingly, so that uncontrolled and abrupt torques caused by wind gusts barely occur or have no or only have minimal effect on the assembly-compatible position alignment of the rotor.

The movable sliding carriage possesses here a correspondingly configured carrier element that receives and fixes the cable carriers. In this way, the cable carriers are movement-flexible and can perform relative movements to each other, which compensates and balances sudden rotational movements that may occur, so that the lifted rotor remains in its optimal assembling position or can immediately afterwards orient itself accordingly.

In another advantageous embodiment of the solution according to present invention is provided that the guiding plane comprises a stop element which limits the freedom of movement of the sliding carriage. The stop element, which can be attached on the guiding plane, can be formed, for example, as a simple pin or clip element. Here the stop element acts as a brake element against the movement of the sliding carriage along the guiding plane. This is advantageous to prevent possible undesirably appearing torque movements that would make an alignment of the rotor during the assembling more difficult, according to the size of the wind power facility and the rotors to be lifted.

It is furthermore advantageous that the stop element can be attached to any position of the guiding plane as limiting means. The guiding plane can be configured accordingly for that purpose. It would be conceivable, for example, to provide bores in a certain distance from each other in the guiding plane, so that a bolt-like element or a plug can be inserted. Possibly, the guiding plane can also have notches or grooves, which give the necessary extra hold to a limiting means which is formed as a clamp or clip-like element. The stop element here can be arranged on the guide rail in such a manner that the rotor is in the necessary position for the assembling, when the sliding carriage abuts the stop element. Depending on the orientation of the rotor shaft, the rotor must be aligned accordingly so as to be able to mount onto the rotor flange. Commonly, the axis of the rotor shaft is tilted by approximately 4 degrees with respect to the horizontal plane. For assembling, the axis of the hub must therefore also be tilted by 4 degrees. In comparison with the center of gravity of the entire rotor, the receiving devices are attached to the blade root regions, and the stop elements are provided on the guide rails in such a manner that the rotor axis of the rotor can align with the axis of the rotor shaft on its own, the assembling is simplified considerably. In the prior art, this alignment is only possible by means of manual balancing of two cranes.

Another embodiment of the invention discloses that the rail or the guiding plane is configured with constant radius towards the center of gravity of the rotor. It is thereby achieved that in any position of the sliding carriage on the rail, the rotor is balanced and hangs on the lifting device without any tendency to tip. The rail is designed here preferably as a circle around a tipping axis or pitching axis.

For the inventive solution, it may be also advantageous if each of the half shells of the receiving device owns an underside facing the blade root and if an elastic layer, which may also be applied directly onto the underside of the half-shells, protects the surface of the rotor in load situations. Wear by abrasion and friction can be prevented or at least minimized in this way. However, likewise, a rubber elastic layer is also producing the necessary support during the lifting process of the rotor, in that the receiving device slip is very difficult, and thereby no disturbing torque of the rotor is caused, which would possibly result in an unfavorable change in the assembling position of the rotor.

### BRIEF DESCRIPTION OF THE DRAWINGS

In the following, exemplary embodiments of the inventive lifting device will be explained in more detail based on a drawing.

In the drawings:

FIG. 1 shows a first embodiment of the invention of a lifting device for a rotor in a first substantially horizontal position,

FIG. 2 shows a detailed section of a receiving device of FIG. 1, which is fixed to a root region of a rotor blade of the wind turbine,

FIG. 3 shows a further view of the lifting device of FIG. 1, wherein the rotor is in a second substantially vertical position, and

FIG. 4 shows a structure of a wind turbine in principle.

### EMBODIMENTS OF THE INVENTION

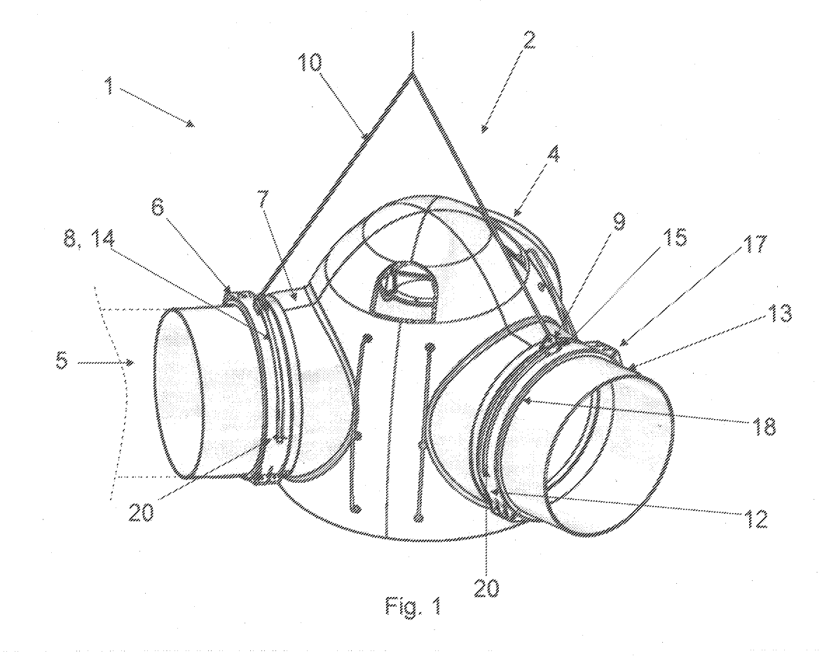

FIG. 1 shows a first embodiment of a lifting device for a rotor 2. The rotor 2 mounted in FIG. 1 on the lifting device 1 is an integral part of a wind turbine 3 (not shown here) and consists of a turbine hub 4 and in FIG. 1 implied rotor blades 5. The rotor 2 is lifted at the installation site with the lifting device 1 so as to be mounted to a flange (not shown here) of a rotor shaft of a turbine housing. The lifting device 1 comprises receiving devices 6, which are fixed to a respective blade root region 7 of the rotor 2. The receiving devices 6 are composed of two half-shells 12 and 13, which are held together by a connecting element 17. At least one half-shell 12 or 13 of each receiving device 6 has a guiding means 8 mounted thereon, which comprises a carrier element 9 for receiving and fixing cable carriers 10. The carrier element 9 is connected to the guiding means 8 in a movement-flexible manner so that the rotor 2 is aligned properly for assembly before assembling on a rotor shaft 11 (not shown in the figure) of the wind turbine 3. In order to ensure a sufficient flexibility of movement of the carrier element 9, a guiding plane 14 is mounted on the guiding means 8, which is formed as a rail or scroll bar. On the guiding plane 14 lies a slide carriage 15, which is restrictedly movable along the guiding plane (and is provided if it is needed by the facility). On the slide carriage 15, the carrier element 9 is mounted, which acts as the receiving and fixing means for cable carriage 10 of the not shown lifter. The half-shells 12 and 13 have under surfaces 18 respectively, which may be provided with an elastic, particularly rubber-like layer. On one hand, this layer protects the surface of the blade root region under load from abrasion or other damages. On the other hand, it can provide sufficient strength to hold the half-shells 12 and 13 immovably on the blade root region. The guiding plane 14 or more specifically the rail of a half-shell 12 or 13 also has a stop element 16 which limits the freedom of movement of the sliding carriage 15. The stop element 16 is constructed as a pin-like bolt in the illustrated embodiment, which is attached to the guiding plane 14. Here, the guiding plane 14 can be constructed in such a manner that the stop element 16 can be set at any position so as to be able to limit the amount of movement freedom of the sliding carriage 15 as needed.

In FIG. 1 the rotor 2 is shown in a substantially horizontal position and hangs on the cable 10. Then the pre-assembled rotor of the wind turbine, i.e. hub and rotor blades fixed thereon, lies on the ground, wherein the region, which faces to the nacelle of the wind turbine in the assembled state, faces to the ground. If the rotor 2 is lifted by means of cable 10, then the whole rotor 2 starts to rotate, as the cable 10 does not run in the line of gravity center of the rotor. Only the tip of the rotor blade, which is not provided with a lifting device 1, is not lifted. In order not to let this to be dragged on the ground, a smaller crane can lift this as well, thus avoiding damages to the blade tip.

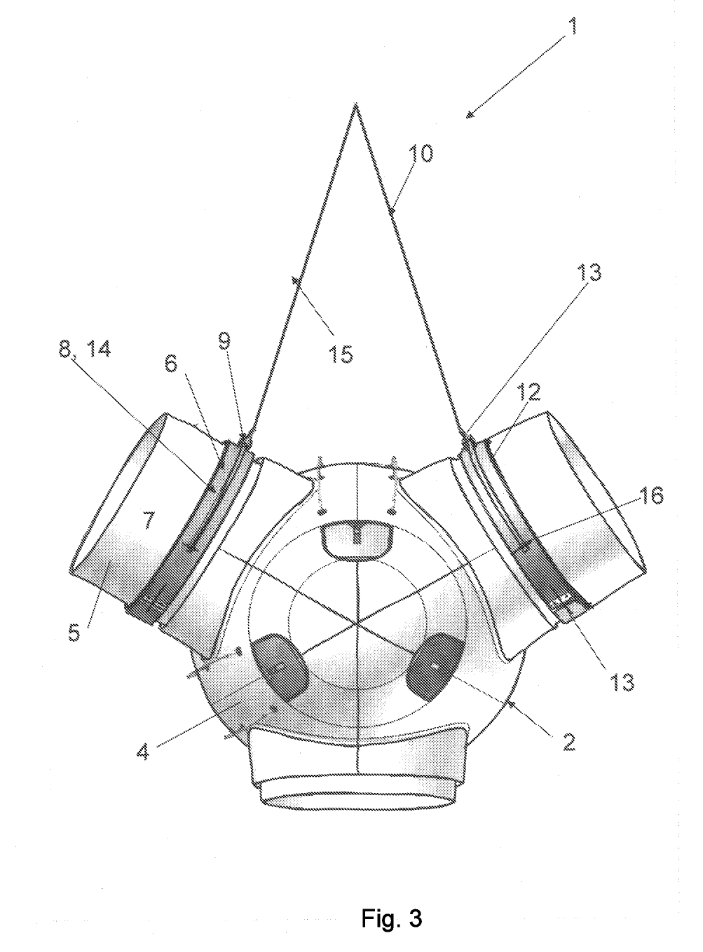

The higher the lifting device is lifted, the stronger the rotor rotates due to the eccentricity of the gravity center of the cables 10, wherein the sliding carriage 15 moves slowly on the rails in accordance with the displacing direction 21. Once the entire rotor 2 is lifted higher than the rotor blade length, then the third rotor blade now does not touch the ground any more and do not need to be supported by a crane any more. This now substantially vertically oriented rotor is shown in FIG. 3. The sliding carriages now lie against the stop elements 20 and are located in the centroidal axis or plane of the rotor 2.

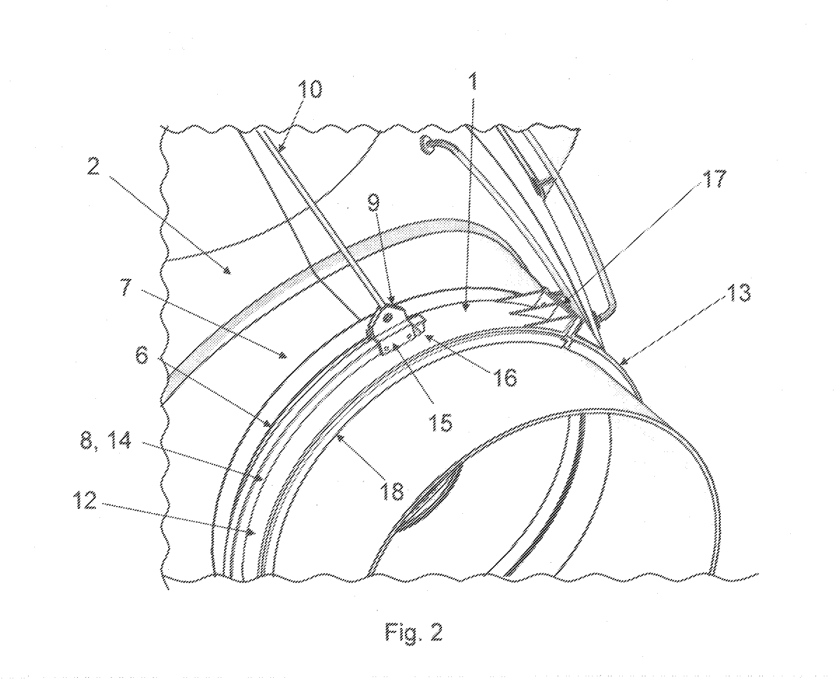

FIG. 2 shows the details of a receiving device according to FIG. 1, which is fixed to a rotor blade region of a turbine hub. Here, FIG. 2 corresponds to FIG. 1 in principle. However, the limit stop element 16 is shown more clearly in FIG. 2 as a pin-shaped bolt, which limits the movement of the sliding carriage 15 on the guiding plane 14.

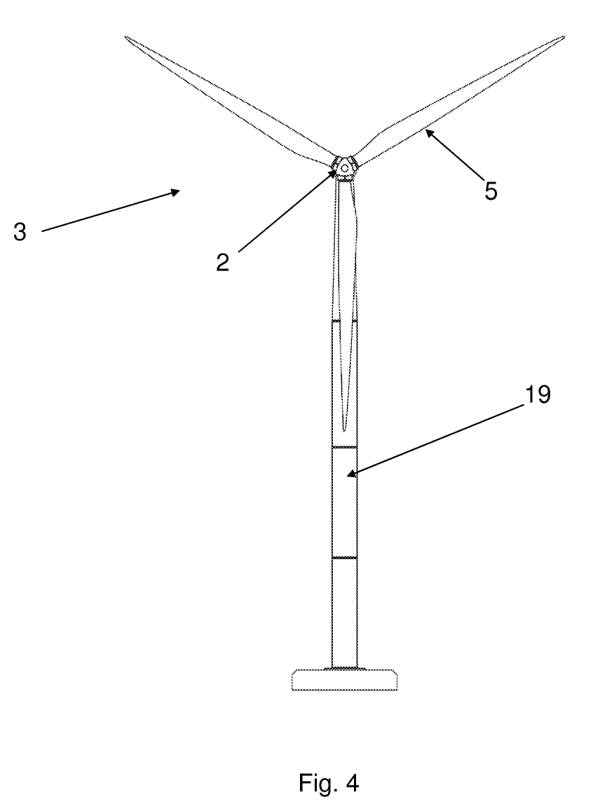

FIG. 4 shows a basic design of a wind turbine facility as an example. The wind turbine facility 3 has a rotor 2, consisting of a turbine hub 4 and rotor blades 5 and a tower base with a foundation 19.

Reference sign list

| | |
|---|---|
| 1 | Lifting device |
| 2 | Rotor |
| 3 | Wind turbine facility |
| 4 | Turbine hub |
| 5 | Rotor blade |
| 6 | receiving device |
| 7 | Blade root region |
| 8 | Guiding element |
| 9 | Carrier element |
| 10 | Cable carrier |
| 11 | Rotor shaft |
| 12 | First half-shell |
| 13 | Second half-shell |
| 14 | Guiding plane |
| 15 | Sliding carriage |
| 16 | Stop element |
| 17 | Connecting element |
| 18 | Underside of the receiving device |
| 19 | Tower base with foundation |
| 20 | Stop element |
| 21 | Displacing direction |

1. A lifting device (1) for a rotor (2) of a wind turbine (3), which is composed of at least one turbine hub (4) and two rotor blades (5) fixed thereon, and the lifting device (1) comprising at least two receiving devices (6) which can be fixed to a blade root region (7) of the rotor (2), wherein
the receiving device (6) is firmly but detachably connectable to the blade root area (7),
guiding means (8) and at least one carrier element (9) for receiving and fixing cable carriers (10) are arranged on the receiving device (6),
wherein the carrier element (9) is moveably mounted on the guide means (8).

2. The lifting device (1) according to claim 1, wherein the receiving device (6) is composed of at least two half-shells (12, 13) which enclose firmly the blade root region (7) in assembled state.

3. The lifting device (1) according to claim 1, wherein the guiding means (8) has a guiding plane (14) with a sliding carriage (15) mounted thereon, wherein the sliding carriage (15) is restrictedly movable in at least one degree of freedom along the guiding plane (14).

4. The lifting device (1) according to claim 3, wherein the sliding carriage (15) receives the carrier element (9) for receiving and fixing the cable carriers (10).

5. The lifting device (1) according to claim 3, wherein the guiding plane (14) has a stop element (16) which limits the freedom of movement of the sliding carriage (15).

6. The lifting device (1) according to any one of claim 3, wherein the guiding plane (14) is constructed in such a manner that the stop element (16) can be attached at any position of the guiding plane (14) as a limiting means.

7. The lifting device (1) according to claim 6, wherein the stop element (16) is attached at a position of the guiding plane (14) as a limiting means in such a manner that the rotor (2) is aligned properly for assembly before being assembled on a flange of a rotor shaft of the wind turbine.

8. The lifting device (1) according to claim 1, wherein the half-shells (12, 13) of the receiving device (6) are held together by a form-fitting and/or force-fitting connection via a connecting element (17).

9. The lifting device (1) according to claim 1, wherein the receiving device (6) has a underside (18) facing to the blade root area, on which an elastic layer is provided to protect the surface of the rotor blade (5) in load situations.
